(19) United States
(12) Patent Application Publication
(10) Pub. No.: US 2011/0034848 A1
(43) Pub. Date: Feb. 10, 2011

(54) COMPRESSION BANDAGE FOR MAMMALS, IN PARTICULAR FOR HORSES

(75) Inventor: Franz LUTZ, Aichach/Ecknach (DE)

Correspondence Address: Fleit Gibbons Gutman Bongini & Bianco PL, 21355 EAST DIXIE HIGHWAY, SUITE 115, MIAMI, FL, 33180, US

(73) Assignee: JULIUS ZORN GMBH, Aichach (DE)

(21) Appl. No.: 12/850,344

(22) Filed: Aug. 4, 2010

(30) Foreign Application Priority Data
Aug. 8, 2009 (DE) 102009036792.6

(51) Int. Cl. A61D 9/00

(52) U.S. Cl. 602/63; 602/76

(57) ABSTRACT

The present invention relates to a compression bandage for mammals, in particular for horses, comprising a tubular bandage (1) made of an elastic textile material, which can be opened and closed along a longitudinal slit (2) by means of fastening elements. To design this type of bandage in such a manner that it can be applied to the leg of a mammal using the easiest possible technique and that it can ensure an excellent fit even over an extended period of time so that the most uniformly constant and defined compressive pressure is exerted by the bandage on the leg of the mammal, the present invention proposes that the fastening elements comprise a zipper (3) which extends along the longitudinal slit (2), at last one fastener strap (4) which, when closed, straddles the longitudinal slit (2) in the transverse direction, and a hook fastener (5) which extends along the longitudinal slit (2).

### CROSS REFERENCE TO RELATED APPLICATIONS

This application claims priority under 35 U.S.C. §119 to German Patent Application No. 10 2009 036 792.6 filed Aug. 8, 2009, the entire contents of which are incorporated herein by reference.

### FIELD OF THE INVENTION

The present invention relates to a compression bandage.

### BACKGROUND OF THE INVENTION

Due to the fact that horses are increasingly stabled in stalls, “blown up legs” are a frequently observed phenomenon. In addition, there is an increasing number of cases of chronic phlegmons and edemas on the legs of horses and idiopathic synovitis and tendovaginitis (wind galls) in horses, frequently without an identifiable cause. Syndromes of this type have so far been treated by applying bandages which are wrapped around the leg of the horse to create a compression bandage. This type of treatment, however, is time- and labor-intensive, and the bandage that is wrapped around the leg of the horse tends to easily slide out of position. In addition, these compression bandages are unable to ensure that a defined compressive pressure is produced. More specifically, the compressive pressure can decrease as the time worn increases. However, a sufficiently high compressive pressure on the muscles of the equine leg is required in order to improve the blood return, which in turn makes it possible to prevent “blown up legs” and edemas. If, on the other hand, the bandage is too tightly wrapped around the leg, pressure sores can develop.

From the prior art it is known to use tubular compression bandages which are pulled over the leg of the horse or are secured on the equine leg. For example, DE 84 06 480.3 U1 discloses a compress for the leg of a quadruped, in particular a riding horse, which compress is made from an elastically compressing stocking material which is fashioned into a tubular stocking that is open on both ends. This tubular stocking is pulled over the leg of the horse and causes uniform compression, thereby ensuring that blood congestion in the equine leg is avoided. However, applying this tubular compress to the leg is time- and labor-intensive. In addition, for the tubular stocking to be pulled over the equine leg, the horse has to lift its leg.

DE 38 11 900 C2 describes a bandage for the cannon bone of horses, which bandage has a substantially quadrilateral contour, with a number of straps disposed along one lateral edge of this contour, which straps extend parallel to the upper and lower edge of the contour. To apply the bandage to the cannon bone of the horse, a first hook and loop fastener (Velcro fastener) is disposed on the free ends of the straps, which is effectively operative within a strip-like section on the outside of the contour so as to create a Velcro fastener. In addition, a second hook and loop fastener (Velcro fastener) that is independent of the first fastener is provided, which comprises a strip-like section that is operative on the lateral edge facing away from the straps on the outside of the contour and an additional strip-like section that is operative on the inside of the contour. When the bandage is wrapped around the cannon bone of the horse, first the second hook and loop fastener (Velcro fastener) is closed and subsequently the straps are wrapped around the cannon bone and secured by means of the first hook and loop fastener (Velcro fastener) to an adhesive strip on the outer surface of the bandage. This provides a multi-layer configuration in a circumference of the bandage, which is to ensure an especially snug fit without the risk that the bandage gradually slides down into the direction of the fetlock when the horse puts weight on its leg. The horse can wear this bandage even during competitions since it ensures a secure fit on the cannon bone, for example, even in show jumping competitions. However, the hook and loop fasteners (Velcro fasteners) cannot be relied upon to provide long-term support because they tend to become loose, which in turn causes the compressive pressure exerted by the bandage on the cannon bone to decrease when the bandage is worn for an extended period of time.

### SUMMARY OF THE INVENTION

Against this background, the problem to be solved by the present invention is to construct a generic bandage in such a manner that it can be applied to the leg of the mammal using the simplest possible technique and that it ensures a snug fit on the leg of the mammal so that a defined compressive pressure that is as uniformly constant as possible is exerted by the bandage on the leg of the mammal.

This problem is solved by a compression bandage for mammals with the features of Claim 1. Preferred embodiments of this bandage follow from the dependent claims.

### BRIEF DESCRIPTION OF THE DRAWINGS

The invention will be explained in greater detail below based on a practical example with reference to the appended drawings. The practical example concerns a compression bandage for horses. The compression bandage according to the present invention can also be used for other mammals. The drawings show:

FIG. 1: a lateral view of a compression bandage according to the present invention,

FIG. 2: a front view of the compression bandage according to the present invention seen in FIG. 1,

FIG. 3: an illustration of the compression bandage according to the present invention seen in FIG. 1 in an unfolded state which shows the inner surface of the bandage, and

FIG. 4: an illustration of a compression pad which can be used as an element of the compression bandage according to the present invention, with FIG. 4a showing the inner surface of the compression pad in the unfolded state, FIG. 4b showing a lateral view of the compression pad, and FIG. 4c showing a plan view of the compression pad.

### DETAILED DESCRIPTION OF THE INVENTION

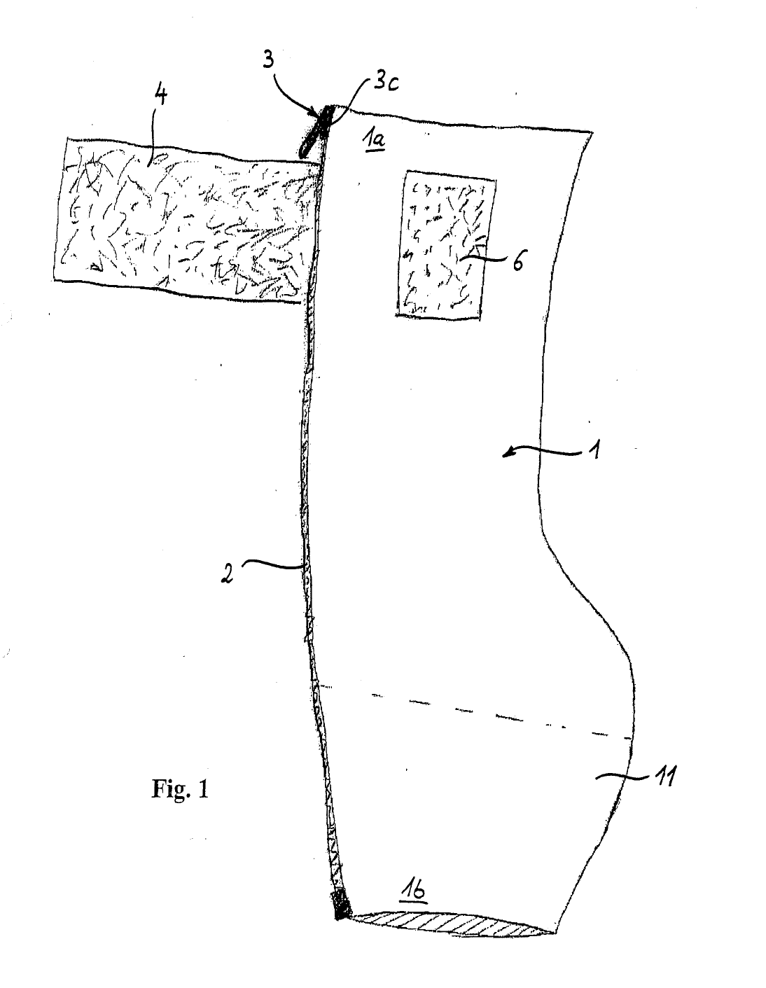

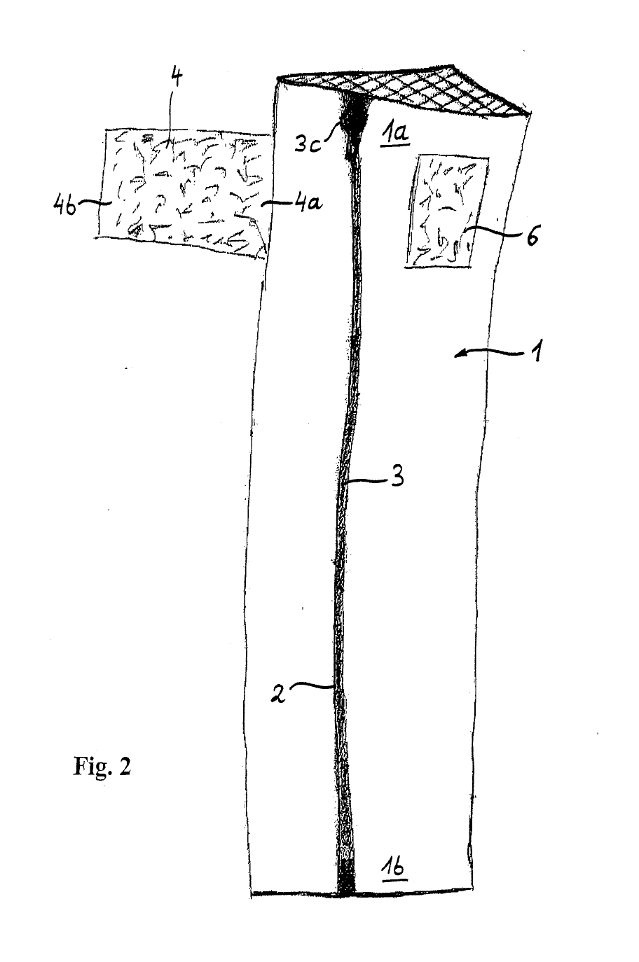

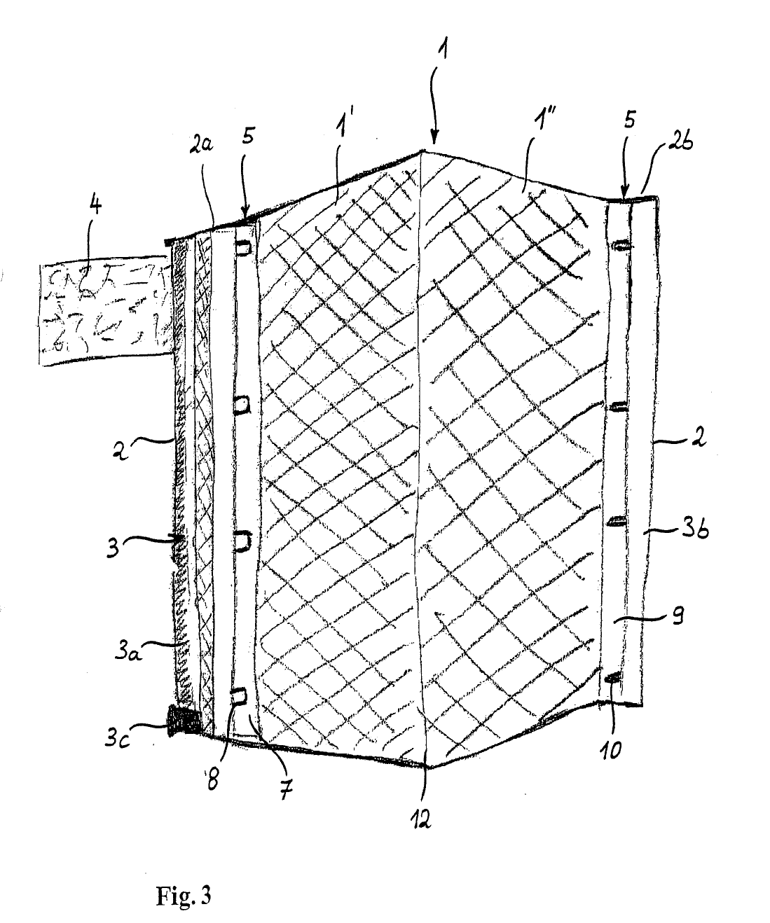

The compression bandage shown in FIGS. 1-3 comprises a tubular bandage 1 made of an elastic textile material, preferably a low-stretch textile material. Low-stretch bandages have a high working pressure and a low pressure at rest to ensure decompression. The bandage 1 comprises a longitudinal slit 2 which extends in the longitudinal direction of the bandage 1 and across the total length of the bandage 1. The bandage 1 can be opened and closed via this longitudinal slit. The bandage 1 is preferably made of an elastic flat knitted material and comprises two parts, with part 1′ and part 1″ being sewn together along a seam 12 (as shown in FIG. 3). The elastic textile material involved is preferably an elastic and air-permeable knitted fabric of the type used in the production of compression articles for use in human medicine, for example, in the treatment of lymphedemas, lipedemas and phlebedemas.

To be able to close and open the bandage 1 along the longitudinal slit 2, fastening elements 3, 4 and 5 are disposed on the bandage 1. The fastening elements comprise a zipper 3, the two lateral tapes 3a,3b of which are sewn to the two oppositely disposed sides 2a and 2b of the longitudinal slit 2 along the bandage 1. The zipper 3 comprises a slider 3c by means of which the teeth disposed along the lateral tapes 3a,3b of the zipper 3 can be hooked into and unhooked from one another by sliding the slider 3c along the lateral tapes 3a,3b. The zipper 3 is preferably disposed in such a manner that it is closed from the end 1b of the bandage 1, which in FIG. 3 is the lower end, to the upper end 1a.

On the upper end of the bandage 1, a fastening strap 4 is disposed, which, when in the closed position, straddles the longitudinal slit 2 in the transverse direction. The fastening strap is preferably made of a non-elastic textile fabric or a synthetic (e.g., nylon) and disposed at the uppermost possible end 1a of the bandage 1 or at least near the upper end 1a. One end 4a of the fastening strap 4 is attached, for example, sewn or glued, to the outer surface of the bandage 1. The other end 4b of the fastening strap 4 can be connected to the outer surface of the bandage 1 by means of a Velcro fastener (loop or hook fastener). To create the hook and loop fastener, the inner surface of the fastening strap 4 that faces the bandage 1 has a fleeced or loop surface which interacts with the hook strap 6 that is attached to the outer surface of the bandage 1. The hook strap 6 is secured, for example, sewn, to the outer surface of the bandage 1 and comprises barbs which hook into the loops or the fleeced surface of the inner surface of the fastening strap 4 so as to create the hook and loop fastener when the inner surface of the fastening strap 4 is laid on and pressed to the hook strap 6 while exerting slight pressure.

In addition, hook fasteners 5 are disposed along the longitudinal slit 2. The hook fasteners 5 are formed by an eyeleted strap 7 with eyelets 8 and a hook strap 9 with hooks 10 that mate with the eyelets 8. On the inner surface of the bandage 1, the eyeleted strap 7 is sewn into the edge region of side 2a next to the longitudinal slit 2. On side 2b which lies opposite side 2a of the longitudinal slit 2, the hook strap 9 is sewn to the inner surface of the bandage 1. The eyelets 8 of the eyeleted strap 7 and the hooks 10 of the hook strap 9 are aligned, respectively, along the eyeleted strap and the hook strap in such a manner that each hook 10 lies opposite its corresponding eyelet 8. The hook fasteners 5 are closed by hooking a hook 10 into its corresponding eyelet 8. Both the eyeleted strap 7 and the hook strap 9 extend along the longitudinal slit 2 across the total length of the bandage 1.

As shown in FIG. 1, the shape of the bandage 1 is adapted to the anatomy of the limbs of the mammal to which the bandage is to be applied. In the upper region 1a in which the fastening strap 4 is disposed, the bandage 1 has a substantially tubular shape and a circumference which is approximately equivalent to the circumference of the cannon bone of the mammal. By adjusting the circumferential size of the bandage 1 to the circumference of the cannon bone, it is possible to specifically determine the compressive pressure that is to be exerted on the cannon bone. In the lower region 1b, the bandage 1 has a bulge 11 with a diameter or circumference larger than that of the tubular upper region 1a.

When the bandage 1 is to be applied to the cannon bone of the horse, the bandage 1 is first opened by opening the fastener elements 3,4,5 and wrapped around the cannon bone of the horse in such a manner that the bandage completely enwraps the cannon bone. To this end, the bandage 1 is placed around the cannon bone in such a manner that the outer surface of the bandage to which the fastening strap 4 is attached is positioned on the outside. Subsequently, the fastening strap 4 is first wrapped around and closed by positioning the inner surface of the fastening strap 4 onto the hook strap 6 to which it is attached by exerting slight pressure so as to close the Velcro fastener. This makes it possible to preliminarily affix the bandage 1 in the correct position to the cannon bone of the horse. Subsequently, the hook fasteners 5 are closed, preferably from the bottom (i.e., from the lower end 1b) to the top, by hooking each hook 10 into its corresponding eyelet 8. In this manner, the bandage 1 is affixed to the cannon bone. Finally, the zipper 3 is closed from the bottom to the top. The zipper 3 ensures that the bandage 1 is securely affixed to the cannon bone and that a defined compressive pressure is exerted on the cannon bone. When both the hook fasteners 5 and the zipper 3 are closed, the eyeleted strap 7 and the hook strap 9 are positioned underneath the zipper 3. If the zipper 3 is to be closed completely, the fastener strap 4 can be temporarily opened, and after the slider 3c has been pulled all the way up to the upper end of the zipper 3, it can again be closed. When closed, the fastener strap 4 straddles the longitudinal slit 2 and the zipper 3 at right angles with respect to the bandage.

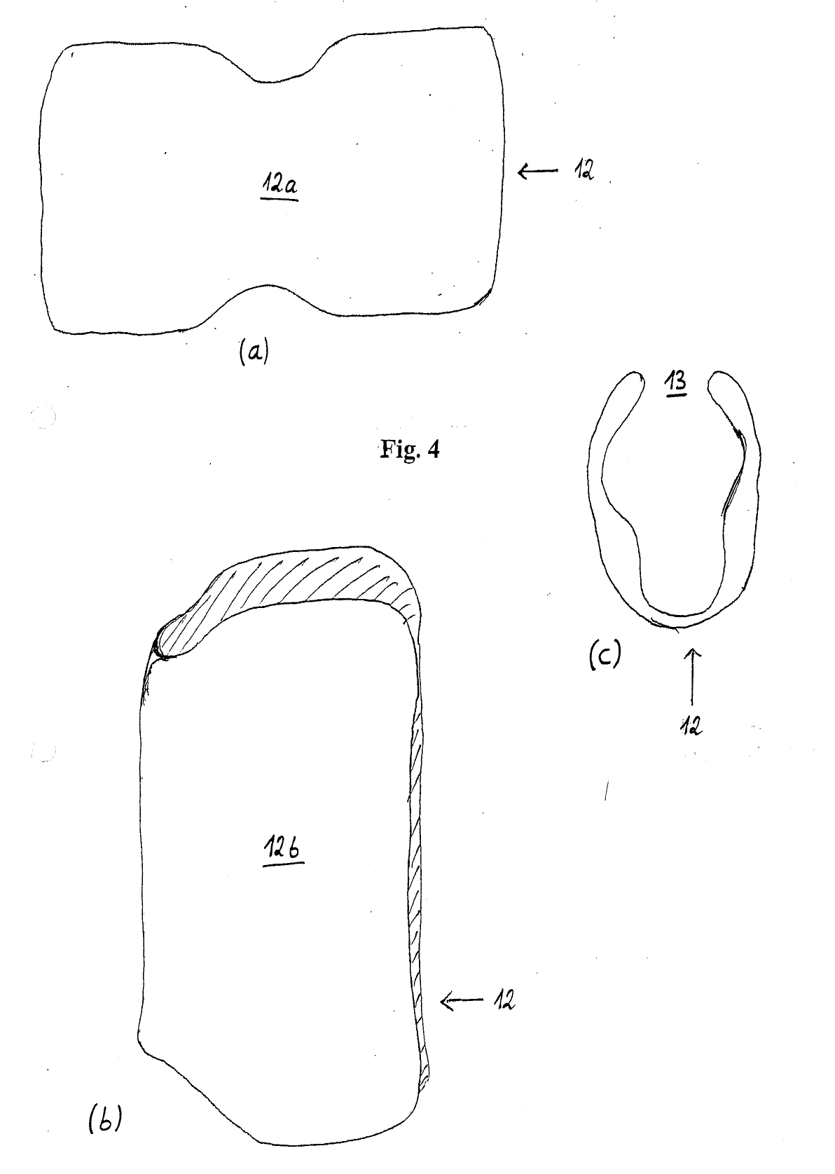

In a preferred embodiment of the compression bandage according to the present invention, a compression pad 12 can be used in addition to the bandage 1. The compression pad 12 shown in FIG. 4 is disposed between the cannon bone of the horse and the inner surface of the bandage 1. The compression pad 12 involved is a dimensionally stable and substantially tubular gaiter which has a full-length slit 13 on the front surface. Via this longitudinal slit 13, the compression pad 12 can be placed around the cannon bone of the horse, and by exerting a tensile force on the ends adjacent to the longitudinal slit 13, the dimensionally stable compression pad 12 can be slightly stretched, thereby expanding the longitudinal slit 13 in such a manner that the compression pad 12 can be pushed over the cannon bone of the horse. Because of the dimensional stability of the compression pad 12, the inner surface 12a of the compression pad 12 clings to the anatomical shape of the cannon bone when the tensile force exerted on the ends adjacent to the longitudinal slit 13 is removed.

As FIG. 4c shows, the shape of the inner surface 12a of the compression pad 12 is adapted to the anatomical shape of the cannon bone of the horse. The compression pad 12 is made of a soft material, for example, an expanded material, microcellular rubber or a soft synthetic material, and comprises an outer cover that can preferably be removed for cleaning This makes it possible to prevent pressure sores on the cannon bone of the horse, which can develop when the compressive pressure applied is too high. The compression pad 12 makes it possible to equilibrate potential pressure differences of the bandage 1 covering it and to distribute them uniformly across the surface over the entire circumference. Because of the compression pad 12, less pressure is exerted, in particular cranially and caudally, onto the cannon bone and the flexor tendon. In addition, the compression pad 12 also functions to support the cannon bone. Furthermore, the compression pad 12 serves to protect the tendon and can prevent injuries, for example, caused by blows against the leg during training or show jumping competitions. The bandage according to the present invention (with or without compression pad) can be used to compress different limbs of mammals, with the size and the shape of the bandage (and, if present, of the compression pad), in particular its circumference, being adapted to the anatomical size and shape of the limbs to which the bandage is to be applied.

The compression bandage according to the present invention can be used in medical treatments and for prophylaxis as well as in training sessions or competitions. Bandages according to the present invention can similarly be used to prevent muscular soreness and pain from overexertion. The optimum compressive pressure for achieving the desired effect is in a range from 28-32 mm Hg (measured with the contact pressure sensor manufactured by KIKUHIME).

To achieve an antibacterial effect, a silver thread can be knitted into the knitted textile fabric of the bandage 1. The use of a bandage 1 with a knitted-in silver thread is recommended, for example, after surgery. Similarly, the cover of the compression pad 12 can have a knitted-in silver thread or a silver coating, thereby eliciting an antibacterial and thermodynamic effect on the cannon bone.

What is claimed is:

1. A compression bandage for mammals, in particular for horses, comprising a tubular bandage made of an elastic textile material which can be opened and closed along a longitudinal slit by means of fastening elements that are disposed on the bandage, wherein the fastening elements comprise a zipper that extends along the longitudinal slit, at least one fastener strap which, when closed, straddles the longitudinal slit in the transverse direction, and hook fasteners which extend along the longitudinal slit.

2. The compression bandage as in claim 1, wherein the longitudinal slit and the zipper extend across the total length of the bandage.

3. The compression bandage as in claim 1, wherein the fastener strap is disposed on one end or near one end of the bandage.

4. The compression bandage as in claim 1, wherein one end of the fastener strap is attached to the bandage, and the other end can be connected to the bandage by means of a loop or hook fastener.

5. The compression bandage as in claim 1, wherein the fastener strap consists of a non-elastic textile fabric.

6. The compression bandage as in claim 1, wherein the inside of the fastener strap facing the bandage has a fleeced or loop surface which interacts with a hook strap that is attached to the outer surface of the bandage so as to form a Velcro fastener.

7. The compression bandage as in claim 3, wherein the zipper can be closed from the lower end of the bandage to the upper end on which the fastener strap is disposed.

8. The compression bandage as in claim 1, wherein on the inner surface of the bandage, an eyeleted strap with eyelets is disposed in the edge region adjacent to the longitudinal slit on one side and a hook strap with hooks corresponding to the eyelets is disposed on the opposite side.

9. The compression bandage as in claim 8, wherein the eyeleted strap and the hook strap extend along the longitudinal slit across the total length of the bandage.

10. The compression bandage as in claim 8, wherein the eyeleted strap and the hook strap are positioned underneath the zipper when the hook fastener is closed.

11. The compression bandage as in claim 1, wherein the bandage is adapted to the anatomical shape of the limbs of the mammal to which the bandage is to be applied.

12. The compression bandage as in claim 11, wherein the upper region of the bandage in which the fastener strap is disposed has a tubular shape and a diameter that is approximately equivalent to the diameter of the cannon bone of the mammal and that the lower region has a bulge with a larger diameter.

13. The compression bandage as in claim 1, wherein it also includes a compression pad which is disposed between the limb of the mammal to be treated and the bandage.

14. The compression bandage as in claim 13, wherein the shape of the compression pad is adapted to anatomical shape of the limb of the mammal to be treated.

15. The compression bandage as in claim 13, wherein the compression pad involved is a substantially hollow cylindrical gaiter made of a soft material which has a longitudinal slit.

16. The compression bandage as in claim 1, wherein the textile material involved is a short-stretch textile material.

17. The compression bandage as in claim 1, wherein the compressive pressure exerted by the bandage on the limb of the mammal to which the bandage is applied is in a range from 28-32 mm Hg.
